(19) United States
(12) Patent Application Publication
(10) Pub. No.: US 2024/0141104 A1
(43) Pub. Date: May 2, 2024

(54) LIQUID 1,3-DIOXOLANE COPOLYMERS

(71) Applicant: WACKER CHEMIE AG, Munich (DE)

(72) Inventors: Laura Ascherl, Olching (DE); Martina Baumann, Sauerlach (DE); Theresa Dellermann, Munich (DE)

(73) Assignee: Wacker Chemie AG, Munich (DE)

(21) Appl. No.: 18/276,346

(22) PCT Filed: Feb. 17, 2021
(86) PCT No.: PCT/EP2021/053905

§ 371 Date: Aug. 8, 2023

(51) Int. Cl. C08G 65/26

(52) U.S. Cl. CPC C08G 65/2639

(57) ABSTRACT

Copolymers and methods of making the same. The copolymers are 1,3-Dioxolane copolymers of the general formula I where x1+x2 has values of 10 to 2000. Where R¹ and R² are hydrogen radicals or C₁ to C₁₈ alkyl radical. In each case at least one radical R¹ or R² in the units [O—CH₂—O—CHR¹—CHR²-]_{y1} and [O—CHR¹—CHR²O—CH₂-]_{y2} is a C₁ to Cis alkyl radical. Where y1+y2 has values of 3*(x1+x2+y1+y2)/100 to 50*(x1+x2+y1+y2)/100.

The invention relates to 1,3-dioxolane copolymers of 1,3-dioxolane and alkyl-substituted 1,3-dioxolane and to a process for the production thereof.

The serious contribution of increased CO₂ emissions to climate change is undisputed, and it is not only since the signing of the Paris Climate Agreement that the reduction of CO₂ emissions has been an important factor for stopping the increase in the average global temperature.

Not insignificant amounts of CO₂ are emitted into the atmosphere also in the production of plastics; according to projections by the EIT Climate-KIC, by 2050 15-20% alone of global CO₂ emissions will be attributable to the production of plastics.

One way to counter this trend is to utilize CO₂ in plastics production, and to integrate CO₂ into the value chain not as waste but as starting material.

In this context, polyacetals represent an attractive class of plastics, it being possible to produce them via the intermediate of cyclic acetals inter alia by catalytic fixing of CO₂ with green hydrogen.

However, conventional polyacetals, also called polyoxymethylenes (POM), such as those obtainable, for example, by polymerization of formaldehyde or trioxane (POM-H) or by ring-opening polymerization of 1,3-dioxolane (POM-C), are solid at room temperature since the polymers have crystalline subsections and an associated melting point, which, depending on the use, impedes further processing or functionalization.

The aim of the present invention was therefore to obtain polyacetals which are liquid over a wide temperature range and can be produced from cyclic acetals.

The intention of the controlled incorporation of imperfections in the form of alkyl groups which protrude from the polymer backbone is to eliminate the crystallinity of the polyacetal, not just to reduce it. Such amorphous behavior can be detected by way of differential scanning calorimetry measurements if there is only a glass transition point but no melting point.

U.S. Pat. No. 7,030,207 BB describes polyacetals formed from trioxane and 1,3-dioxolane, the crystallization temperature of which can be reduced, but the polymers crystallize below a certain temperature.

The publication “Thermal stability and dynamic mechanical properties of acetal copolymers” Angew. Makromol. Chem. 1999, 265, 55-61 describes the copolymerization of trioxane with alkylated 1,3-dioxolanes, but no liquid products are obtained.

Masahiko Okada et al., “Polymerizability of Methyl Substituted 1,3-Dioxolanes” Makromolekulare Chemie 176, 859-872 (1975) describes the homopolymerization of 4-methyl-1,3-dioxolane to form a viscous polymer, with monomer and polymer being present in equilibrium. The polymerization requires low temperatures and very long reaction times of several days.

EP3020741A describes the possibility of producing copolymers from 1,3-dioxolane and other monomers. Properties of the copolymers are not described.

The invention provides 1,3-dioxolane copolymers of the general formula I

H—[O—CH₂—O—CH₂—CH₂-]ₓ₁[O—CH₂—CH₂O—CH₂-]ₓ₂

[O—CH₂—O—CHR¹—CHR²-]_{y1}[O—CHR¹—CHR²O—CH₂-]_{y2} OH (I),

in which
x1+×2 has values of 10 to 2000,
R¹ and R² are hydrogen radicals or C₁ to C₁₈ alkyl radical, where in each case at least one radical R¹ or R² in the units [O—CH₂—O—CHR¹—CHR²-]_{y1} and [O—CHR¹—CHR²O—CH₂-]_{y2} is a C₁ to C₁₈ alkyl radical,
with the proviso that y1+y2 has values of 3−(x1+x2+y1+y2)/100 to 50−(x1+x2+y1+y2)/100.

The copolymers are formed from 1,3-dioxolane and 1,3-dioxolane substituted in the 4-position and/or 5-position. They are liquid over a wide temperature range and therefore of very good suitability for further processing.

They preferably have a glass transition between −50° C. and −70° C. and especially preferably have no melting point. The copolymers start to decompose at >110° C., in particular at >100° C.

The 1,3-dioxolane copolymers comprise the units [O—CH₂—O—CH₂—CH₂-]ₓ₁, [O—CH₂—CH₂O—CH₂-]ₓ₂, [O—CH₂—O—CHR¹—CHR²-]_{y1}, [O—CHR¹—CHR²O—CH₂-]_{y2}, randomly or in blocks.

Preferably x1+×2 has values of 20 to 1000, particularly preferably of 30 to 500, in particular of 50 to 300.

Examples of alkyl radicals R¹ and R² are linear and branched alkyl radicals, such as the methyl, ethyl, i-octyl and n-octyl radical, and cycloalkyl radicals, such as the cyclohexyl radical. Preferably R¹ and R² are hydrogen radicals or C₁ to C alkyl radicals, particularly preferably hydrogen radicals or methyl, ethyl, n-propyl or i-propyl radicals.

Preferably in each case only one radical R¹ or R² in the units [O—CH₂—O—CHR¹—CHR²-]_{y1} and [0-CHR¹—CHR²O—CH₂-]_{y2} is a C₁ to C₁₈ alkyl radical.

Preferably y1+y2 has values of 5−(x1+x2+y1+y2)/100 to 40−(x1+x2+y1+y2)/100, particularly preferably values of 10−(x1+x2+y1+y2)/100 to 30−(x1+x2+y1+y2)/100, in particular values of 14−(x1+x2+y1+y2)/100 to 25−(x1+x2+y1+y2)/100.

The 1,3-dioxolane copolymers preferably have a molecular weight Mw of between 750-300 000, particularly preferably between 1500-125 000, very particularly preferably between 2200-63 000, in particular between 4000-25 000.

The 1,3-dioxolane copolymers preferably have a dynamic viscosity at 25° C. of between 50 mPas-500 Pas, particularly preferably between 500 mPas-200 Pas, in particular between 1 Pas-100 Pas.

The 1,3-dioxolane copolymers of the general formula I above can be produced in a simple manner and with short reaction times.

The invention also provides a process for producing the 1,3-dioxolane copolymers of the general formula I above,

H—[O—CH₂—O—CH₂—CH₂-]ₓ₁[O—CH₂—CH₂O—CH₂-]ₓ₂

[O—CH₂—O—CHR¹—CHR²-]_{y1}[O—CHR¹—CHR²O—CH₂-]_{y2} OH (I),

in which
x1+×2 has values of 10 to 2000,
R¹ and R² are hydrogen radicals or C₁ to C₁₈ alkyl radical, where in each case at least one radical R¹ or R² in the units [O—CH₂—O—CHR¹—CHR²-]_{y1} and [O—CHR¹—CHR²O—CH₂-]_{y2} is a C₁ to C₁₈ alkyl radical,
with the proviso that y1+y2 has values of 3*(x1+x2+y1+y2)/100 to 50*(x1+x2+y1+y2)/100,
in which process 1,3-dioxolane is copolymerized with alkyl-substituted 1,3-dioxolane of the general formula II

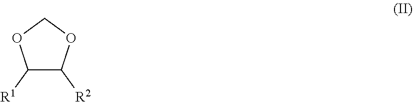

in the presence of a Lewis or Brønsted acid.

In the general formula II, there are alkyl radicals R¹ and R² in the 4- and 5-position of the 1,3-dioxolanes.

The process is a ring-opening polymerization of the dioxolane monomers by way of cationically induced catalysis. The catalyst is a Lewis or Brønsted acid.

In the process, preferably at least 10 mol %, particularly preferably at least 20 mol %, in particular at least 30 mol % of alkyl-substituted 1,3-dioxolane of the general formula II, based on the total amount of 1,3-dioxolane and alkyl-substituted 1,3-dioxolane of the general formula II, is used.

Since alkyl-substituted 1,3-dioxolane of the general formula II is less reactive than 1,3-dioxolane, it is necessary in the process to use more of it than is arithmetically necessary in order to achieve a certain proportion of values y1+y2.

Examples of acids are Lewis acids, such as BF₃, AlCl₃, TiCl₃, SnCl₄, SO₃, PCIs, POCl₃, FeCl₃ and its hydrates and ZnCl₂; Brønsted acids, such as boric acid, tetrafluoroboric acid, nitric acid, nitrous acid, phosphoric acid, phosphorous acid, hypophosphorous acid, sulfuric acid, sulfurous acid, peroxysulfuric acid, hydrochloric acid, hydrofluoric acid, hydroiodic acid, hydrobromic acid, perchloric acid, hexafluorophosphoric acid, aluminum chloride, zinc chloride, benzenesulfonic acid, p-toluenesulfonic acid, methanesulfonic acid, trifluoromethanesulfonic acid and carboxylic acids, such as chloroacetic, trichloroacetic, acetic, acrylic, benzoic, trifluoroacetic, citric, crotonic, formic, fumaric, maleic, malonic, gallic, itaconic, lactic, tartaric, oxalic, phthalic and succinic acids, acidic ion exchangers, acidic zeolites, acid-activated bleaching earth and acid-activated carbon black.

Particular preference is given to boron trifluoride etherate and trifluoromethanesulfonic acid.

Initiators may be used in the process. The initiator used is preferably a mono- or difunctional alcohol, particularly preferably ethylene glycol.

The process may be performed in the presence or in the absence of aprotic solvents. If aprotic solvents are used, preference is given to solvents or solvent mixtures with a boiling point or boiling range of up to 120° C. at 0.1 MPa. Examples of such solvents are ethers, such as dioxane, tetrahydrofuran, diethyl ether, methyl tert-butyl ether, diisopropyl ether, diethylene glycol dimethyl ether; chlorinated hydrocarbons, such as dichloromethane, trichloromethane, tetrachloromethane, 1,2-dichloroethane, trichloroethylene; hydrocarbons, such as pentane, n-hexane, hexane isomer mixtures, heptane, octane, benzine, petroleum ether, benzene, toluene, xylenes; siloxanes, particularly linear dimethylpolysiloxanes with trimethylsilyl end groups having preferably 0 to 6 dimethylsiloxane units, or cyclic dimethylpolysiloxanes having preferably 4 to 7 dimethylsiloxane units, for example hexamethyldisiloxane, octamethyltrisiloxane, octamethylcyclotetrasiloxane and decamethylcyclopentasiloxane;
ketones, such as acetone, methyl ethyl ketone, diisopropyl ketone, methyl isobutyl ketone (MIBK); esters, such as ethyl acetate, butyl acetate, propyl propionate, ethyl butyrate, ethyl isobutyrate; carbon disulfide and nitrobenzene, or mixtures of these solvents.

The term “solvent” does not mean that all reaction components must dissolve therein. The reaction may also be performed in a suspension or emulsion of one or more reactants. The reaction may also be performed in a solvent mixture with a miscibility gap, at least one reactant in each case being soluble in each of the mixed phases.

Particularly preferably, a solution of trifluoromethanesulfonic acid and an initiator is used, with methylene chloride being used as preferred solvent.

The amount of catalyst and initiator used determines the achievable molecular weight of the 1,3-dioxolane copolymer of the general formula I.

The process is preferably performed at a temperature of between 10° C. and 60° C., particularly preferably between 15° C. and 40° C., in particular between 21° C. and 30° C. A reaction temperature of 23° C. is very particularly preferred.

The reaction is preferably worked up by inactivating the catalyst by means of a suitable base, washing with a hydrocarbon, such as heptane, and drying under reduced pressure.

Suitable bases are preferably pyridine, triethylamine or aqueous sodium hydroxide solution.

In the examples which follow, unless stated otherwise in each case, all figures for amounts and percentages are based on weight, all pressures are 0.10 MPa (abs.) and all temperatures are 20° C.

### EXAMPLES

### Analysis for the Entire Invention:

NMR Spectroscopy to Determine the Proportion of Alkyl Ethylene Oxide Bridges y1+y2:

The measurement is effected in solution in CDCl₃ on a Bruker Avance 500 or Ascend 500 (500 MHz for ¹H spectrum). All measurements are referenced against TMS as external standard. The relative ratios of the monomer units in the polymer are determined by integrating the respective sets of signals.

### SEC (Size-Exclusion Chromatography) to Determine the Number-Average and Mass-Average Molecular Weights Mn, Mw and the Polydispersity:

The measurement is effected against a polystyrene standard, in THF, at 35° C., flow rate 0.3 ml/min and detection with RID (refractive index detector) on an Agilent PLgel MiniMIX-C Guard column with an injection volume of 20 μl.

### Rheometer to Determine the Dynamic Viscosity:

The measurement is effected on an Anton Paar MCR 320 rotational viscometer at 25° C. The graphical evaluation is performed by plotting viscosity against shear stress.

### DSC (Differential Scanning Calorimetry/Differential Thermal Analysis) to Determine the Melting Point and the Glass Transition Temperature:

The measurement is effected on a Mettler Toledo DSC-1 device in a temperature range of −150° C. to 150° C. in two runs with a heating or cooling rate of 10 K/min, the second run being used to determine the melting point and the glass transition temperature.

### TGA Analysis to Determine the Start of Decomposition:

The start of decomposition (onset) is determined on a Mettler Toledo TGA-2 device, the sample being heated at a heating rate of 10 K/min in an oxygen atmosphere.

### Example 1, Non-Inventive

8.0 ml (114 mmol) of 1,3-dioxolane (DXL) is placed in a flask and 14 μl of boron trifluoride etherate is added while stirring. An increase in viscosity can be observed, after 10 min the reaction solution is solid. 5 ml of a 5% by weight sodium carbonate solution is added. The mixture is dissolved in dichloromethane, and the product is precipitated in heptane and filtered. The white solid is dried under reduced pressure.

### Example 2

3.6 ml (50 mmol) of 1,3-dioxolane (DXL) and 5.1 g (50 mmol) of 4-ethyl-1,3-dioxolane (EDX) are placed in a flask and 14 μl of boron trifluoride etherate is added while stirring. An increase in viscosity can be observed. After 4 h, 5 ml of a 5% by weight sodium carbonate solution is added and the product is washed with heptane. The viscous residue is dried under reduced pressure.

### Example 3

5.2 ml (75 mmol) of 1,3-dioxolane (DXL) and 2.55 g (25 mmol) of 4-ethyl-1,3-dioxolane (EDX) are placed in a flask and 14 μl of boron trifluoride etherate is added while stirring. An increase in viscosity can be observed. After 2 h, it is no longer possible to stir the reaction mixture. 5 ml of a 5% by weight sodium carbonate solution and dichloromethane are added and the product is precipitated in heptane. The highly viscous, white residue is dried under reduced pressure.

### Example 4

5.8 ml (83 mmol) of 1,3-dioxolane (DXL) and 1.74 g (17 mmol) of 4-ethyl-1,3-dioxolane (EDX) are placed in a flask and 14 μl of boron trifluoride etherate is added while stirring. The reaction is highly exothermic and an increase in viscosity can be observed. After 5 min, it is no longer possible to stir the reaction mixture. 5 ml of a 5% by weight sodium carbonate solution and 5 ml of dichloromethane are added and the product is precipitated in heptane. The white solid is dried under reduced pressure.

### Example 5

5.1 g (50 mmol) of 4-ethyl-1,3-dioxolane (EDX) and 14 μl of boron trifluoride etherate are placed in a flask. Within 15 min, while stirring 3.6 ml (50 mmol) of 1,3-dioxolane (DXL) is added dropwise while stirring. The reaction mixture is stopped after 2 h by addition of 5 ml of a 5% by weight sodium carbonate solution. After addition of dichloromethane, the product is washed with heptane and dried under reduced pressure. The result is a viscous oil.

### Example 6

2.55 g (25 mmol) of 4-ethyl-1,3-dioxolane (EDX) and 14 μl of boron trifluoride etherate are placed in a flask. Within 30 min, 4.2 ml (60 mmol) of 1,3-dioxolane (DXL) is added dropwise while stirring. The reaction mixture is stopped after 2 h by addition of 5 ml of a 5% by weight sodium carbonate solution. After addition of dichloromethane, the product is added dropwise to heptane, the heptane phase is removed and the residue is dried under reduced pressure. The result is a viscous oil.

### For Examples 7 to 10

### Preparation of the Catalyst Solution:

10 ml of dry dichloromethane, 1000 μl of ethylene glycol and 76 μl of trifluoromethanesulfonic acid are combined and stirred for 1 h at room temperature.

### Example 7

4.5 ml of catalyst solution and 4.5 ml of dry dichloromethane are placed in a flask and adjusted to a temperature of 23° C. 67.5 g (640 mmol) of 4-ethyl-1,3-dioxolane (EDX) and 45 ml (640 mmol) of 1,3-dioxolane (DXL) are then added and stirred. The reaction turns pink.

After 4.5 h, pyridine is added until the mixture loses its color. The product is washed with heptane and then dried under reduced pressure.

### Example 8

9.0 ml of catalyst solution is placed in a flask and adjusted to a temperature of 23° C. 67.5 g (640 mmol) of 4-ethyl-1,3-dioxolane (EDX) and 45 ml (640 mmol) of 1,3-dioxolane (DXL) are then added and the reaction mixture is stirred for 60 min at 21° C. The reaction mixture turns pink. After 5.5 h, pyridine is added until the mixture loses its color. The product is washed with heptane and then dried under reduced pressure.

### Example 9

0.25 ml of catalyst solution and 0.25 ml of dichloromethane are placed in a flask. 3.75 g (35 mmol) of 4-ethyl-1,3-dioxolane (EDX) and 2.5 ml (35 mmol) of 1,3-dioxolane (DXL) are then added and the mixture is stirred for 3 h at 23° C. 10 ml of dichloromethane is added to the reaction and then 10% sodium hydroxide solution is added dropwise until a pH of 7. The product is washed with twice with 20 ml of water and dried under reduced pressure.

### Example 10

0.25 ml of catalyst solution and 0.25 ml of dichloromethane are placed in a flask. 800 mg (8 mmol) of 4-ethyl-1,3-dioxolane (EDX) and 4.7 ml (67 mmol) of 1,3-dioxolane (DXL) are then added and the mixture is stirred at 23° C. After 4 h, 1 ml of pyridine and 5 ml of dichloromethane are added. After addition of heptane, the supernatant is decanted off and the product is dried under reduced pressure. The result is a white solid.

TABLE

| | | | | | | | | |
|---|---|---|---|---|---|---|---|---|
| | n (DXL) | n (EDX) | Incorporation | Mn in | Mw in | | | |
| Example | in mmol | in mmol | of EDX in % | g/mol | g/mol | PDI | Tm | Tg |

Catalyst: BF₃—Et₂O

| | | | | | | | | |
|---|---|---|---|---|---|---|---|---|
| 1* | 114 | 0 | 0 | 4500 | 11 300 | 2.54 | 55° C. | −60° C. |
| 2 | 50 | 50 | 19 | 7515 | 24 458 | 3.25 | — | −62° C. |
| 3 | 75 | 25 | 9 | 5770 | 19 729 | 3.42 | 21° C. | −62° C. |
| 4 | 83 | 17 | 7 | 12 910 | 54 341 | 4.21 | 26° C. | −61° C. |
| 5 | 50 | 50 | 16 | 2040 | 4980 | 2.4 | — | −62° C. |
| 6 | 60 | 25 | 14 | 4100 | 12 100 | 3.0 | — | −62° C. |

Catalyst solution: Trifluoromethanesulfonic acid/ethylene glycol in methylene chloride

| | | | | | | | | |
|---|---|---|---|---|---|---|---|---|
| 7 | 640 | 640 | 19 | 7960 | 22 080 | 2.7 | — | −62° C. |
| 8 | 640 | 640 | 17 | 3740 | 8720 | 2.3 | — | −62° C. |
| 9 | 35 | 35 | 10 | 4200 | 12 695 | 3.0 | 14° C. | −62° C. |
| 10 | 67 | 8 | 4 | 7070 | 31 400 | 4.4 | 33° C. | −62° C. |

*non-inventive

1-8. (canceled)

9. Copolymers, comprising:
wherein the copolymers are 1,3-Dioxolane copolymers of the general formula I
H—[O—CH₂—O—CH₂—CH₂-]ₓ₁[O—CH₂—CH₂O—CH₂-]ₓ₂
[O—CH₂—O—CHR¹—CHR²-]_{y1}[O—CHR¹—CHR²O—CH₂-]_{y2} OH (I),
wherein x1+×2 has values of 10 to 2000;
wherein R¹ and R² are hydrogen radicals or C₁ to C₁₈ alkyl radical, where in each case at least one radical R¹ or R² in the units [O—CH₂—O—CHR¹—CHR²-]_{y1} and [O—CHR¹—CHR²O—CH₂-]_{y2} is a C₁ to C₁₈ alkyl radical; and
wherein y1+y2 has values of 3*(x1+x2+y1+y2)/100 to 50*(x1+x2+y1+y2)/100.

10. The copolymers of claim 9, wherein the radicals R¹ and R² are selected from hydrogen radicals or methyl, ethyl, n-propyl or i-propyl radicals.

11. The copolymers of claim 9, wherein in each case only one radical R¹ or R² in the units [O—CH₂—O—CHR¹—CHR²-]_{y1} and [O—CHR¹—CHR²O—CH₂-]_{y2} is a C₁ to C₁₈ alkyl radical.

12. The copolymers of claim 9, wherein the 1,3-Dioxolane copolymers have a molecular weight Mw of between 750-300 000, measured against a polystyrene standard, in THF, at 35° C., flow rate 0.3 ml/min and detection with RID (refractive index detector) on an Agilent PLgel MiniMIX-C Guard column with an injection volume of 20 μl.

13. The copolymers of claim 9, wherein the 1,3-Dioxolane copolymers have a dynamic viscosity at 25° C. of between 50 mPas-500 Pas, measured on an Anton Paar MCR 320 rotational viscometer at 25° C., where the graphical evaluation is performed by plotting viscosity against shear stress.

14. A process for producing copolymers, comprising:
providing copolymers, wherein the copolymers are 1,3-Dioxolane copolymers of the general formula I
H—[O—CH₂—O—CH₂—CH₂-]ₓ₁[O—CH₂—CH₂O—CH₂-]ₓ₂
[O—CH₂—O—CHR¹—CHR²-]_{y1}[O—CHR¹—CHR²O—CH₂-]_{y2} OH (I),
wherein x1+×2 has values of 10 to 2000,
wherein R¹ and R² are hydrogen radicals or C₁ to C₁₈ alkyl radical, where in each case at least one radical R¹ or R² in the units [O—CH₂—O—CHR¹—CHR²-]_{y1} and [O—CHR¹—CHR²O—CH₂-]_{y2} is a C₁ to C₁₈ alkyl radical,
wherein y1+y2 has values of 3*(x1+x2+y1+y2)/100 to 50*(x1+x2+y1+y2)/100,
copolymerizing the 1,3-dioxolane copolymers with alkyl-substituted 1,3-dioxolane of the general formula II 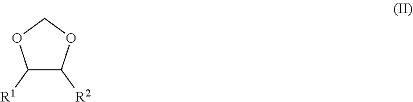
wherein the copolymerization process occurs in the presence of a Lewis or Brønsted acid.

15. The process of claim 14, wherein the acid is selected from boron trifluoride etherate and trifluoromethanesulfonic acid.

16. The process of claim 14, wherein the temperature is between 10° C. and 60° C.
